(19) United States
(12) Patent Application Publication
(10) Pub. No.: US 2003/0228480 A1
(43) Pub. Date: Dec. 11, 2003

(54) Procedure for manufacturing a composite material with temperature-resistant bonding agent and a composite material manufactured according to the procedure

(75) Inventors: Roland Bothor, Aachen (DE); Jens Danckwortt, Aachen (DE); Michael Wolters, Heinsberg (DE); Johannes Linden, Aachen (DE)

Correspondence Address: Russell D. Orkin., WEBB ZIESENHEIM LOGSDON ORKIN & HANSON, P.C., 700 Koppers Building, 436 Seventh Avenue, Pittsburgh, PA, 15219-1818, US

(73) Assignee: SIG Combibloc Systems GmbH, Linnich (DE)

(21) Appl. No.: 10/419,722

(22) Filed: Apr. 21, 2003

(30) Foreign Application Priority Data
Apr. 22, 2002 (DE) 102 17 941.7

(51) Int. Cl. B32B 31/00

(52) U.S. Cl. 428/514; 156/82; 156/272.2; 156/272.8; 156/272.6

(57) ABSTRACT

Shown and described herein is a procedure for manufacturing a composite material with temperature-resistant bonding agent and a composite material manufactured according to this procedure, in particular for sterilizable, pasteurizable or autoclavable packaging, with at least one barrier layer, wherein at least one bonding agent layer is provided to increase adhesion between the barrier layer and a plastic or cardboard layer. To entirely omit the heat post-treatment of the composite material, it is provided that the layer to be coated be heat treated before applying the bonding agent layer. The dimensions of the coating systems and associated investments are reduced as a result.

The invention relates to a procedure for manufacturing a composite material, in particular for sterilizable, pasteurizable or autoclavable packaging, with at least one barrier layer, wherein at least one bonding agent layer is provided to increase adhesion between the barrier layer and a plastic or cardboard layer, as well as a composite material manufactured according to such a procedure.

Composite materials of varying design are known in the area of packaging, in particular with respect to food products. Paper or cardboard is here generally used as the substrate; a lamination comprised of different layers ensures the tightness required for the respective application, and hence the shelf life of the respectively packaged product. To make such a composite material heat sealable, the outer layers most often consist of polyethylene (PE) or another suitable, heat sealable thermoplastic polymer.

Numerous products to be packaged, e.g., milk, juice or food products, only retain their quality under aseptic conditions and/or after autoclaving if they are sufficiently protected against light, foreign odors and oxygen. This is accomplished using composite materials with a barrier layer, which are known in the art. The use of bonding agents to increase adhesion between two layers, e.g., a plastic or cardboard layer and a barrier layer, has also been known for a long time. Bonding agent layers are usually comprised of bonding agents designed for normal temperatures of use, e.g., for aseptically filled foods in cardboard packaging. Such bonding agents are applied via laminating, lining, coextrusion or coating procedures, for example, and generally require no special form of heat pre- or post-treatment to achieve optimal adhesion.

However, the aforementioned bonding agents are not suited for use in sterilizable, pasteurizable and autoclavable packaging, since they are destroyed through temperature exposure during sterilization or autoclaving, and lose their bonding properties. Only temperature-resistant bonding agents can therefore be used for this application. But all known bonding agents require heat post-treatment after having been applied to the substrate, e.g., in a coating process.

Executing a heat post-treatment in a heating furnace is already known in the art. In this case, the composite material is heated to a temperature level of approx. 250 to 300° C. to achieve an optimal level of bonding. Such heating furnaces are often integrated into the existing coating systems. As a result, the existing coating systems are built to be large enough to ensure the sufficient retention time of the composite material in the known air or gas furnaces. The disadvantages to this involve a significant space requirement and associated considerable costs. In addition, undesired side effects are generated through contact between air and the composite material surface, such as impaired taste, deterioration in sealing properties, change in printability, etc.

Proceeding from the above, the object of the invention is to configure and further develop the procedure for manufacturing a composite material and a composite material manufactured with the procedure as mentioned at the outset and described in greater detail above in such a way as to entirely omit the heat post-treatment of the composite material. The goal here is to reduce the dimensions of the coating systems and the associated investments.

In terms of the procedure, the object is achieved by heat treating the layer to be coated before applying the bonding agent layer.

A bonding agent layer is hence first applied between the barrier layer to be bonded, e.g., an aluminum foil, and a plastic or cardboard layer. This can be done via lamination, coextrusion, lining or coating. In the ensuing step according to the invention, a relatively high thermal pulse is then briefly applied to the composite material, either on the surface of the layer to be coated or, alternatively, the surface of the layer to be coated facing away from the layer. The thermal energy introduced in this way over a short time is stored in the composite material, and results in a distinct increase in temperature of the composite material. Another bonding agent layer can then be applied along with whatever necessary additional polymer layers to this highly temperature-elevated bond on the barrier side.

The preferably pulsed application of heat according to the invention at a high temperature level and simultaneous temporary storage of thermal energy in the composite leads to very high forces of adhesion on both sides of the barrier layer as the result of the bonding agent activated according to the invention. The degree of adhesion corresponds to the level of strength of composites conventionally activated in heating furnaces.

The heat treatment according to the invention reliably precludes negative changes in properties arising from a downstream thermal heat treatment in a heating furnace.

The type of heat treatment can vary greatly in other configurations of the invention. The thermal energy is preferably achieved through flame treatment, hot air treatment, laser treatment, corona treatment, electrical heating and high-frequency treatment.

In another instruction of the invention, thermal treatment only takes place after a first barrier layer has been applied to a plastic or cardboard layer, and another bonding agent layer and at least one additional barrier layer are subsequently applied on the barrier side.

Various barrier layers can be used for the composite material according to the invention, in particular those made out of metal films, metallized plastic films, ethylene/vinyl alcohol, polyethylene terephthalate, polypropylene, polyvinylidene chloride, polyamide, liquid-crystalline polymers and silicon oxide.

1. A procedure for manufacturing a composite material, in particular for sterilizable, pasteurizable or autoclavable packaging, with at least one barrier layer, wherein at least one bonding agent layer is provided to increase adhesion between the barrier layer and a plastic or cardboard layer,
characterized in that
the layers to be coated are heat treated before applying the bonding agent layer.

2. The procedure according to claim 1,
characterized in that
the heat treatment takes place on the surface of the layer to be coated.

3. The procedure according to claim 1,
characterized in that
the heat treatment takes place on the surface of the layer to be coated facing away from the layer.

4. The procedure according to claim 1 or 2,
characterized in that
heat treatment involves flame treatment.

5. The procedure according to claim 1 or 2,
characterized in that
heat treatment involves hot air treatment.

6. The procedure according to claim 1 or 2,
characterized in that
heat treatment involves laser treatment.

7. The procedure according to claim 1 or 2,
characterized in that
heat treatment involves corona treatment.

8. The procedure according to claim 1 or 2,
characterized in that
heat treatment involves high-frequency treatment.

9. The procedure according to claim 1 or 2,
characterized in that
heat treatment takes place by means of electrical heating.

10. The procedure according to one of claims 1 to 9,
characterized in that
heat treatment is pulsed.

11. The procedure according to one of claims 1 to 10,
characterized in that
heat treatment only takes place after a first barrier layer has been applied to a plastic or cardboard layer, and that another bonding agent layer and at least one additional barrier layer are subsequently applied on the barrier side.

12. A composite material,
characterized in that
it is manufactured according to one of claims 1 to 11.

13. The composite material according to claim 12,
characterized in that
a metal film is used as the barrier layer.

14. The composite material according to claim 12,
characterized in that
a metallized plastic film is used.

15. The composite material according to claim 12,
characterized in that
the barrier layer consists of ethylene/vinyl alcohol (EVOH).

16. The composite material according to claim 12,
characterized in that
the barrier layer consists of polyethylene terephthalate (PET).

17. The composite material according to claim 12,
characterized in that
the barrier layer consists of-polypropylene (PP).

18. The composite material according to claim 12,
characterized in that
the barrier layer consists of polyvinylidene chloride (PVDC).

19. The composite material according to claim 12,
characterized in that
the barrier layer consists of polyamide (PA).

20. The composite material according to claim 12,
characterized in that
the polyamide layer consists of PA6.

21. The composite material according to claim 12,
characterized in that
the barrier layer consists of liquid crystalline polymers (LCP).

22. The composite material according to claim 12,
characterized in that
the barrier layer consists of cyclo-olefin copolymers (COC).

23. The composite material according to claim 12,
characterized in that
the barrier layer consists of silicon oxide.
